(19) United States
(12) Patent Application Publication
(10) Pub. No.: US 2021/0145205 A1
(43) Pub. Date: May 20, 2021

(54) MILK POWDER BREWING MACHINE

(71) Applicant: NINGBO HAWK ELECTRICAL APPLIANCE CO., LTD, Ningbo (CN)

(72) Inventor: Jianlun CHEN, Ningbo (CN)

(21) Appl. No.: 16/992,994

(22) Filed: Aug. 13, 2020

(30) Foreign Application Priority Data
Nov. 20, 2019 (CN) 2019111408017

(51) Int. Cl. A47J 31/40; A47J 31/52; A47J 31/46; B01F 3/12; B01F 15/06; B01F 15/00

(52) U.S. Cl. CPC A47J 31/401; A47J 31/5253; A47J 31/461; B01F 3/12; B01F 2215/0006; B01F 15/00175; B01F 15/00155; B01F 2015/062; B01F 15/066

(57) ABSTRACT

A milk powder brewing machine comprising a shell, a mixing bin, a milk powder box, a water storage tank, a constant-temperature bin, a drip tray, a thick-film heater, a spiral cooling pipe and a controller. An air extraction port is provided on the mixing bin, and a moisture-proof assembly is arranged above the air extraction port. The moisture-proof assembly comprises a draught fan and a wind-shield cover. Water outlet of the water storage tank is connected to a cooling pipe, and a spiral pipe is arranged in the cooling pipe. A normal-temperature water outlet is connected with the cooling pipe, which is further connected with the thick-film heater. The thick-film heater is connected with a spiral cooling pipe, which is further connected with the constant-temperature bin through a spiral pipe. The present disclosure is moisture-proof, may be conveniently disassembled, and is capable of improving the cooling effect.

### TECHNICAL FIELD

This disclosure generally relates to the technical field of milk powder brewing devices, and more particularly, to a milk powder brewing machine.

### BACKGROUND

The conventional milk powder brewing is normally a manual brewing process. The milk powder is manually fed into a milk bottle, then hot water is poured into the bottle, and then the appropriate amount of milk powder and water are mixed such that the liquid milk is obtained. The aforesaid method has the following shortcomings: first, the water temperature is difficult to control. For example, a baby may be scalded if the water temperature is excessively high, and the milk in the bottle may get cold before being finished if the water temperature is excessively low; second, due to the caking problem occur in the brewing process, the liquid milk may be non-uniform, severely affecting a baby's eating; third, the proportion of milk powder and water is hard to master, which makes the liquid milk either thin or thick, resulting in the baby's starvation or indigestion after eating.

As a result, various milk powder brewing machines have appeared in the market. Presently, the machines sold on the market may be mainly divided into two types: one is a manual milk powder brewing machine and the other is an intelligent constant-temperature milk powder brewing machine. Compared with using a feeding bottle, the manual milk powder brewing machine is more convenient, allowing the concentration of milk to be better controlled. However, the operation of the manual milk powder brewing machine is complicated. The intelligent constant-temperature milk powder brewing machine controls the concentration and the temperature of the milk using a computer. As the whole process of the milk powder brewing is not in contact with the milk powder, the brewing efficiency, safety, and convenience are significantly improved. The shortcomings of the conventional intelligent constant-temperature milk brewing machines are: first, hot air in the constant-temperature bin may easily enter the powder outlet of the milk powder box, thus making the powder outlet wet, and the residual hot air entering the milk powder box may wet the milk powder in the milk powder box; second, the height of the feeding bottle mounting platform is not adjustable, to make it universal for various bottles, the distance between the feeding bottle mounting platform and the milk outlet must be long enough; however, when a feeding bottle with a small volume is directly placed on the platform, the excessively long distance between the platform and the milk outlet makes the mouth of the feeding bottle far away from the milk outlet; as a consequence, when receiving milk using a feeding bottle, the splattering of milk may be caused, making the milk receiving inconvenient; even worse, for the feeding bottle must be manually held close to the milk outlet, the milk receiving becomes unsafe; third, the single cooling design leads to a poor cooling effect, and the heating pipes heated by ordinary heating wires fail to achieve an instant heating; fourth, the energy-saving effect is poor, and the water temperature cannot be quickly raised to a preset value; fifth, the cleaning of the mixing bin and the water storage tank is difficult.

In conclusion, it is desirable for those skilled in the art to develop a novel milk powder brewing machine.

### SUMMARY

The purpose of the present disclosure is to provide a milk powder brewing machine. According to the present disclosure, the cooling effect is improved, instant heating and reuse of energy are achieved, the energy-saving effect is enhanced, the adjustable height of the feeding bottle mounting platform is realized and the powder outlet is protected from being wetted.

To achieve the above purpose, the present disclosure adopts the following technical solution: a milk powder brewing machine of the present disclosure comprising a shell, a mixing bin, a milk powder box, a water storage tank, a constant-temperature bin, a drip tray, a thick-film heater and a controller, wherein the thick-film heater, the water storage tank, the milk powder box, the constant-temperature bin and the mixing bin are electrically connected to the controller, wherein the mixing bin is connected with the left side of the shell in a drawing mode, and a milk outlet is arranged below the mixing bin, wherein the drip tray is detachably mounted on the shell and is located below the milk outlet of the mixing bin, wherein the water storage tank is connected with the right side of the shell in an inserting mode, the milk powder box is arranged within the shell, and a powder outlet of the milk powder box is communicated with a powder inlet of the mixing bin, wherein an air extraction port is provided on the mixing bin, and a moisture-proof assembly capable of sucking out the moisture inside the mixing bin is arranged above the air extraction port, wherein the moisture-proof assembly comprises a draught fan with an air inlet facing the air extraction port and a wind-shield cover located above the draught fan, wherein the side edge of the wind-shield cover is provided with a first air outlet hole for releasing the moisture, wherein the constant-temperature bin, the thick-film heater and the controller are located within the shell, and a constant-temperature water outlet formed in the constant-temperature bin is communicated with the mixing bin, wherein a normal-temperature water outlet is formed in the water storage tank, and more than one horizontally-placed first cooling pipe are connected to the normal-temperature water outlet, wherein a horizontally-placed first spiral cooling pipe is arranged below the first cooling pipes, and a second spiral pipe is arranged in each first cooling pipe, wherein the normal-temperature water flowing out from the normal-temperature water outlet is divided and respectively flows into the inlet of each first cooling pipe, wherein after the water flowing out from the first water outlets of all the first cooling pipes join together, the water flows to the thick-film heater, wherein the outlet of the thick-film heater is connected with a second water inlet of the first spiral cooling pipe, and a second water outlet of the first spiral cooling pipe is connected with a constant-temperature water inlet of the constant-temperature bin through a second spiral pipe.

In another aspect of the present disclosure, to improve the cooling effect, there are two first cooling pipes, which respectively are a first cooling pipe A and a first cooling pipe B. A second spiral pipe A is arranged in the first cooling pipe A, and a second spiral pipe B is arranged in the first cooling pipe B. The second water outlet of the first spiral cooling pipe is connected with a third water inlet of the second spiral pipe A, and a third water outlet of the second spiral pipe A is connected with a three-way solenoid valve. The pipeline between the three-way solenoid valve and the second spiral pipe A is provided with a temperature detector capable of transmitting the data information to the controller according to the temperature condition such that the three-way solenoid valve is controlled by the controller to switch between different pipelines. The temperature detector and the three-way solenoid valve are electrically connected to the controller. One ends of the two outlets of the three-way solenoid valve are connected to a three-way pipe, and the other ends of the two outlets of the three-way solenoid valve are connected to the third water inlet of the second spiral pipe B. The first pipe opening of the three-way pipe is connected with the three-way solenoid valve, the second pipe opening of the three-way pipe is connected with the constant-temperature bin, and the third pipe opening of the three-way pipe is connected with the third water outlet of the second spiral pipe B. The bottoms of first cooling pipes are connected to the controller through a communicating pipe.

In another aspect of the present disclosure, to realize real-time monitoring of the flow, a flow meter is arranged at the inlet of the thick-film heater.

In another aspect of the present disclosure, to facilitate the disassembly of the mixing bin, a mounting bin is arranged on the left side of the shell, and sliding strips are arranged on the front side and the rear side inside the mounting bin. The mixing bin is configured to be funnel-shaped, and a top cover for covering the mixing bin is arranged above the mixing bin. The mixing bin is provided with a fourth water inlet, and the fourth water inlet is connected with the second pipe opening of the three-way pipe. The two sides of the mixing bin are provided with sliding grooves matched with the sliding strips, and the sliding grooves are horizontally-arranged Y-shaped sliding grooves. The large opening of the Y-shaped sliding groove serves as an insertion opening matched with the sliding strip, and the end portion of the small opening of the Y-shaped sliding groove is a closed structure. The powder inlet is arranged on the top cover, and the air extraction port is arranged on the top cover.

In another aspect of the present disclosure, to improve the air exhausting efficiency, and finally prevent the powder outlet of the milk powder box from being wetted, the wind-shield cover further comprises a cover plate for covering the whole draught fan. The cover plate is fixed inside the shell, and the right side of the cover plate is provided with an inclined and closed flow guide air duct. The other end of the flow guide air duct is provided with a second channel with an open lower portion and a closed upper portion, and the second channel is communicated with the flow guide air duct. The cover plate and the draught fan are arranged at intervals to form a first air duct, and the first air duct is communicated with the flow guide air duct. There are two or more first air outlet holes, which extend throughout the mixing bin from top to bottom. An air outlet hole of the second channel is communicated with the upper end of the corresponding first air outlet hole, and the lower portion of the first air outlet hole is exposed in the air.

In another aspect of the present disclosure, to facilitate the operation, an operation opening is provided below the mixing bin for allowing users' fingers to enter to draw out the mixing bin from the shell.

In another aspect of the present disclosure, to improve the internal mixing effect, the inner wall of a bowl-shaped pipe of the mixing bin is provided with a spiral-shaped first guide convex rib, and the inner wall of a lower pipe of the mixing bin is provided with a second guide convex rib extending downwards along the interior of the lower pipe. The lower pipe of the mixing bin serves as the milk outlet. The starting point of the second guide convex rib is located in the bowl-shaped pipe of the mixing bin, and the endpoint of the second guide convex rib is flush with the mouth of the milk outlet. A first sealing ring is arranged between the top cover and the mixing bin.

In another aspect of the present disclosure, to achieve a convenient disassembly of the water storage tank, two L-shaped hanging hooks are symmetrically arranged on the right-side surface of the shell, and limiting grooves matched with the hanging hooks are formed in one side surface of the water storage tank. The upper portion of the water storage tank is provided with an opening which serves as the normal-temperature water inlet of the water storage tank, and a handle is hinged within the opening. The upper portion of the normal-temperature water inlet is covered by a water tank cover, and the water tank cover is detachably connected to the normal-temperature water inlet. The normal-temperature water outlet is arranged below the water storage tank, a valve assembly for closing the normal-temperature water outlet is arranged in the normal-temperature water outlet, and a valve switch for opening the valve assembly is arranged on the shell. Guideposts are respectively arranged on two sides of the bottom of the water storage tank, and guide holes matched with the guideposts are formed in the shell. A liquid level sensor for detecting the liquid level in the water storage tank is arranged in the water storage tank, and the liquid level sensor is electrically connected to the controller.

In another aspect of the present disclosure, to make the disassembly convenient, a guide channel extending downwards along the water storage tank is arranged below each limiting groove. The lower portion of the guide channel is a first opening formed in the bottom surface of the water storage tank, and the first opening is not communicated with the interior of the water storage tank.

In another aspect of the present disclosure, to prevent water from leaking from the water outlet during disassembly, transparent observation windows are arranged on two sides of the water storage tank. The valve assembly comprises a push rod, a compression spring, and a first filtering cover. A cross-shaped limiting block is arranged below the push rod, and a second sealing ring matched with the inner wall of the normal-temperature water outlet is sleeved above the push rod. The compression spring is sleeved in the push rod, and the lower end of the compression spring abuts against the limiting block. The second sealing ring is located outside the compression spring. The first filtering cover is fixed above the normal-temperature water outlet, and the first filtering cover covers the push rod and the compression spring located below. The valve switch comprises a push pin matched with the bottom of the limiting block for pushing the limiting block up, and the second sealing ring is separated from the inner wall of the normal-temperature water outlet when the limiting block is pushed up.

In another aspect of the present disclosure, to conveniently store the milk powder, the top of the milk powder box is covered by a milk powder cover, and the milk powder cover is located above the shell.

In another aspect of the present disclosure, to improve the working efficiency while achieving a fast water pumping, a first water pump is arranged on the pipeline connecting the normal-temperature water outlet of the water storage tank and the first cooling pipe A, and a second water pump is arranged between the constant-temperature water outlet of the constant-temperature bin and the pipeline communicated with the mixing bin.

In another aspect of the present disclosure, to make the overall structure more compact, a cooling pipe fixing frame is arranged above the two first cooling pipes, and the cooling pipe fixing frame is fixed within a base of the shell through screws. The two sides of the upper portion of the cooling pipe fixing frame are respectively provided with a supporting frame. The thick-film heater is vertically arranged and is fixed to the supporting frame on the left side through screws. The constant-temperature bin is fixed to the supporting frame on the right side through screws, the first water pump is fixed on the supporting frame on the left side, and the second water pump is fixed on the supporting frame on the right side.

In another aspect of the present disclosure, to make the structure simpler and the operation more convenient, the drip tray is configured to be a recessed structure with an opening in the top, and a sealing cover is arranged on the drip tray. A plurality of first through-holes for allowing water drops to pass through are formed in the sealing cover, and at least two arc-shaped supporting platforms extending upwards from the bottom of the drip tray are arranged in the drip tray. All of the arc-shaped supporting platforms define a circular limiting platform with a gap D between every two adjacent arc-shaped supporting platforms. All the gaps D form a first limiting area, and a second limiting platform is arranged above each arc-shaped supporting platform. All the second limiting platforms form a second limiting area, and the height of the second limiting area is higher than that of the first limiting area. A feeding bottle mounting platform is sleeved outside the circular limiting platform, and positioning rods capable of being inserted into the gaps D are arranged below the feeding bottle mounting platform. After the circular limiting platform is rotated, the positioning rods are placed into the second limiting platform. An operation gap is formed at the lower portion of the left side of the drip tray, and an operation hole is formed in the feeding bottle mounting platform for allowing users' fingers to enter to operate.

In another aspect of the present disclosure, two first magnets are symmetrically arranged on the right side of the drip tray, and a positioning magnet engaged with the upper end of the second limiting platform in an attraction manner is arranged in the positioning rod.

In another aspect of the present disclosure, a second NTC temperature sensor is arranged at the constant-temperature water outlet of the constant-temperature bin, and a first NTC temperature sensor is arranged at the constant-temperature water inlet of the constant-temperature bin. A PTC heater for heating the water in the constant-temperature bin is arranged at the bottom of the constant-temperature bin. The second NTC temperature sensor, the first NTC temperature sensor, and the PTC heater are electrically connected with the controller.

Compared with the prior art, the milk powder brewing machine of present disclosure has the following advantages: first, according to the present disclosure, the water storage tank may be conveniently disassembled and the interior of the constant-temperature bin may be thoroughly cleaned; second, through the arrangement of the moisture-proof assembly, the powder outlet of the milk powder box and the interior of the milk powder box are prevented from being wetted; third, the height of the feeding bottle mounting platform may be adjusted according to actual needs, which realizes a smooth milk receiving, avoids the milk from splattering, and finally makes the feeding bottle mounting platform universal for various feeding bottles; fourth, the constant-temperature effect is significantly improved; fifth, the heat generated during the heat exchange of the first spiral cooling pipe is effectively utilized to preheat the water entering the water heater, which not only ensures the temperature of the water heated by the water heater but also improves the energy-saving effect. As the aforesaid structural design enhances the cooling effect, realizes instant heating, and achieves reuse of energy, the energy-saving effect of the present disclosure is significantly improved.

### BRIEF DESCRIPTION OF THE DRAWINGS

FIG. 1 is a three-dimensional diagram illustrating an example structure of the milk powder brewing machine in embodiment 1 of the preset disclosure.

FIG. 2 is a three-dimensional diagram illustrating an example structure of the milk powder brewing machine in embodiment 1 of the present disclosure after the shell cover is removed.

FIG. 3 is a conceptual diagram illustrating an internal structure of the milk powder brewing machine in embodiment 1 of the present disclosure in one direction after the shell is completely removed.

FIG. 4 is a conceptual diagram illustrating an internal structure of the milk powder brewing machine in embodiment 1 of the present disclosure in another direction after the shell is completely removed.

FIG. 5 is a conceptual diagram illustrating an example structure of the upper portion of the base in embodiment 1 of the present disclosure.

FIG. 6 is a conceptual diagram illustrating an example structure of the left side of the shell in embodiment 1 of the present disclosure after the mixing bin is removed.

FIG. 7 is a conceptual diagram illustrating an internal structure of the mixing bin in embodiment 1 of the present disclosure.

FIG. 8 is a conceptual diagram illustrating an example structure when the mixing bin and the moisture-proof assembly in embodiment 1 of the present disclosure are separated.

FIG. 9 is a conceptual diagram illustrating a bottom view of the mixing bin in embodiment 1 of the present disclosure.

FIG. 10 is a conceptual diagram illustrating an internal structure of the wind-shield cover in embodiment 1 of the present disclosure.

FIG. 11 is a conceptual diagram illustrating an example structure when the mixing bin and the moisture-proof assembly in embodiment 1 of the present disclosure are assembled.

FIG. 12 is a conceptual diagram illustrating an example structure of the right side of the shell in embodiment 1 of the present disclosure after the water storage tank is removed.

FIG. 13 is a conceptual diagram illustrating an enlarged structure of portion A in FIG. 12.

FIG. 14 is a conceptual diagram illustrating a bottom view of the water storage tank in embodiment 1 of the present disclosure.

FIG. 15 is a conceptual diagram illustrating an internal structure of the water storage tank in embodiment 1 of the present disclosure.

FIG. 16 is a conceptual diagram illustrating an example structure of the valve assembly in embodiment 1 of the present disclosure.

FIG. 17 is a conceptual diagram illustrating an internal structure of the feeding bottle mounting platform in embodiment 1 of the present disclosure.

FIG. 18 is a conceptual diagram illustrating an example structure when the drip tray and the sealing cover in embodiment 1 of the present disclosure are separated.

FIG. 19 is a conceptual diagram illustrating an internal structure of the drip tray in embodiment 1 of the present disclosure.

FIG. 20 is a conceptual diagram illustrating the waterway structure connecting the mixing bin, the water storage tank, the constant-temperature bin, the cooling pipe, the three-way solenoid valve, the spiral pipe, the three-way pipe, the first spiral cooling pipe and the thick-film heater in embodiment 1 of the present disclosure.

FIG. 21 is a conceptual diagram illustrating an example structure of the first cooling pipe in embodiment 1 of the present disclosure.

FIG. 22 is a conceptual diagram illustrating an internal structure of the first cooling pipe in embodiment 1 of the present disclosure.

FIG. 23 is a conceptual diagram illustrating an example structure of the constant-temperature bin in embodiment 1 of the present disclosure.

Marking Instructions of the Figures: 1—Shell, 1-1—Base, 2—Mixing Bin, 3—Milk Power Box, 4—Water Storage Tank, 5—Constant-temperature Bin, 6—Drip Tray, 7—Thick-film Heater, 8—Controller, 9—Milk Outlet, 10—Powder Outlet, 11—Powder Inlet, 12—Air Extraction Port, 13—Draught Fan, 14—Wind-shield Cover, 15—The Frist Air Outlet, 16—Normal-temperature Water Outlet, 17—The First Cooling Pipe, 18—The Frist Spiral Cooling Pipe, 19—The Second Spiral Pipe, 20—The Frist Water Outlet, 21—The Second Water Inlet, 22—The Second Water Outlet, 23—Constant-temperature Water Inlet, 24—Communicating Pipe, A17-1—The Frist Cooling Pipe, B17-2—The Frist Cooling Pipe, A19-1—The Second Spiral Pipe, B19-2—The Second Spiral Pipe, 25—Three-way Solenoid Valve, 19-3—The Third Water Inlet, 26—Three-way Pipe, 19-4—The Third Water Outlet, 27—Flow Meter, 28—Mounting Bin, 29—Sliding Strip, 30—Top Cover, 31—The Fourth Water Inlet, 32—Y-shaped Sliding Groove, 33—Insertion Opening, 34—Cover Plate, 35—Flow Guide Air Duct, 36—The Second Channel, 37—The First Air Duct, 38—Operation Opening, 39—The First Guide Convex Rib, 40—The Second Guide Convex Rib, 41—The First Sealing Ring, 42—Hanging Hook, 43—Limiting Groove, 44—Normal-temperature Water Inlet, 45—Handle, 46—Water Tank Cover, 47—Guide Post, 48—Liquid-level Sensor, 49—Guide Hole, 50—Valve Assembly, 51—Guide Channel, 52—The First Opening, 53—Transparent Observation Window, 54—Push Rod, 55—Compression Spring, 56—The First Filtering Cover, 57—Limiting Block, 58—The Second Sealing Ring, 59—Push Pin, 60—Milk Powder Cover, 61—The First Water Pump, 62—The Second Water Pump, 63—Constant-temperature Water Outlet, 64—Cooling Pipe Fixing Frame, 65—Supporting Frame, 66—Sealing Cover, 67—The First Through-hole, 68—Arc-shaped Supporting Platform, 69—Circular Limiting Platform, 70—The First Limiting Area, 71—The Second Limiting Area, 72—Feeding Bottle Mounting Platform, 73—Positioning Rod, 74—Operation Gap, 75—The Second Limiting Area, 76—Temperature Detector, 77—Balance Hole, 78—Infrared Sensor, 79—Operation Hole, 80—The Second NTC Temperature Sensor, 81—The First NTC Temperature Sensor, 82—PTC Heater, 83—The First Magnet, 71-1—Positioning Magnet.

### DETAILED DESCRIPTION

To make the technical solution of the present disclosure easy to understand, drawings are combined hereinafter to further elaborate the implementation of the techniques of the present disclosure.

### Embodiment 1

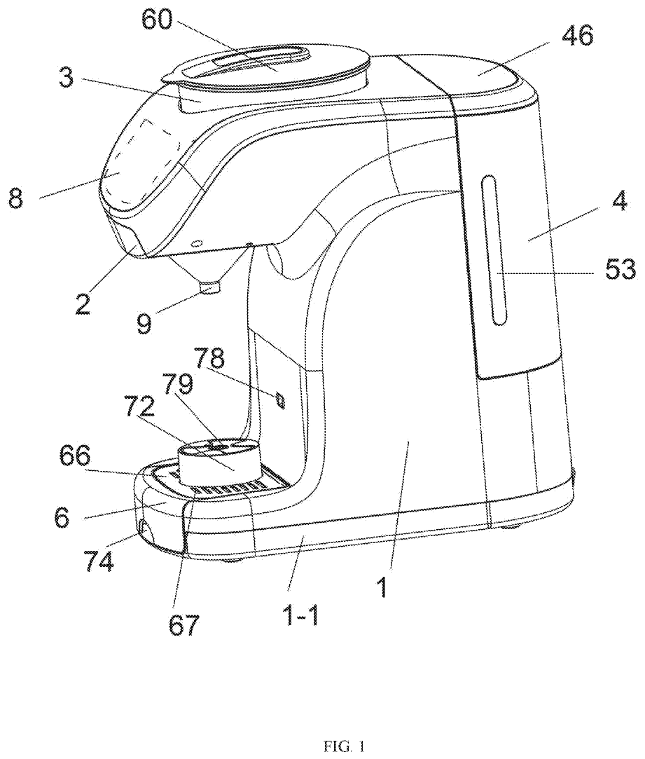

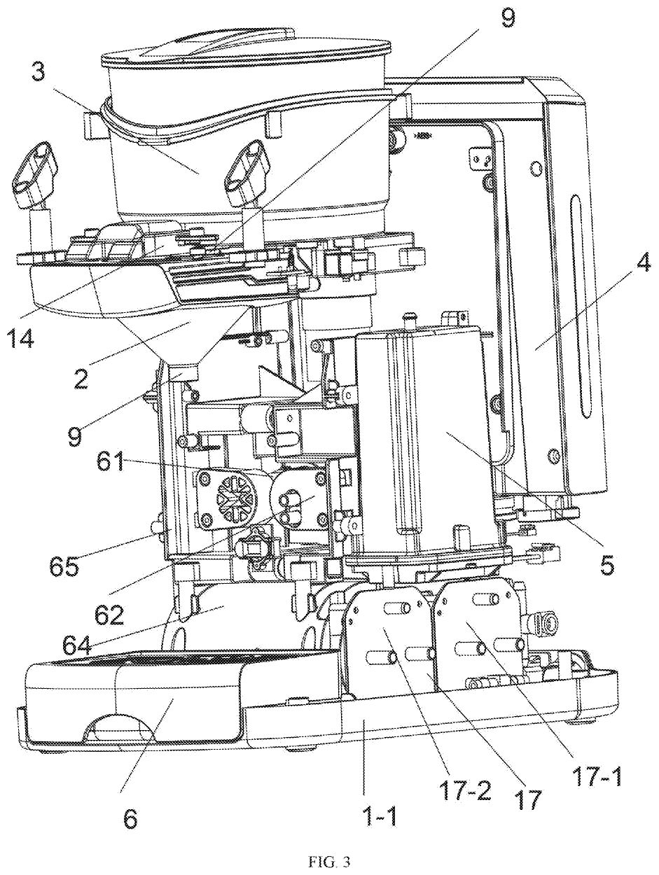

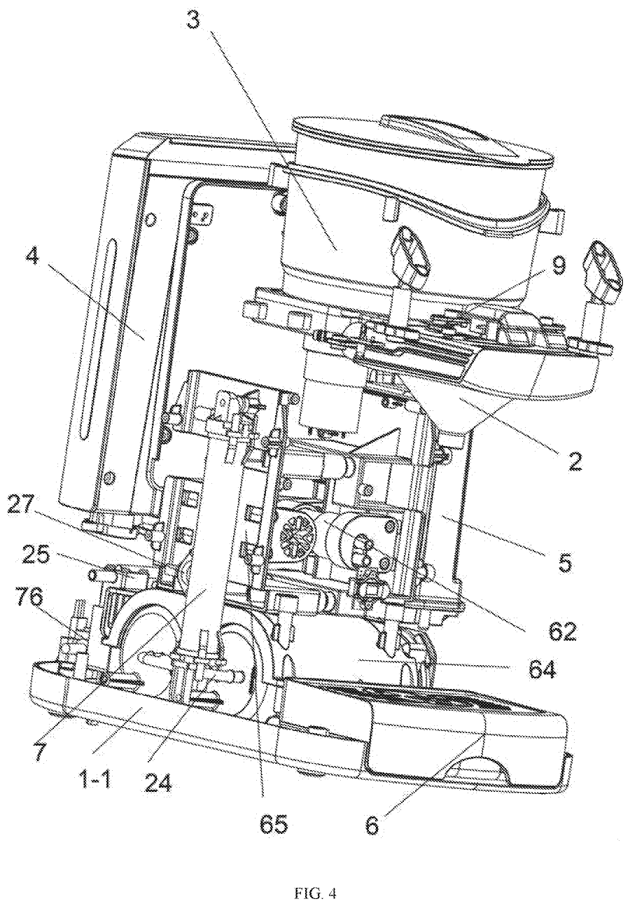

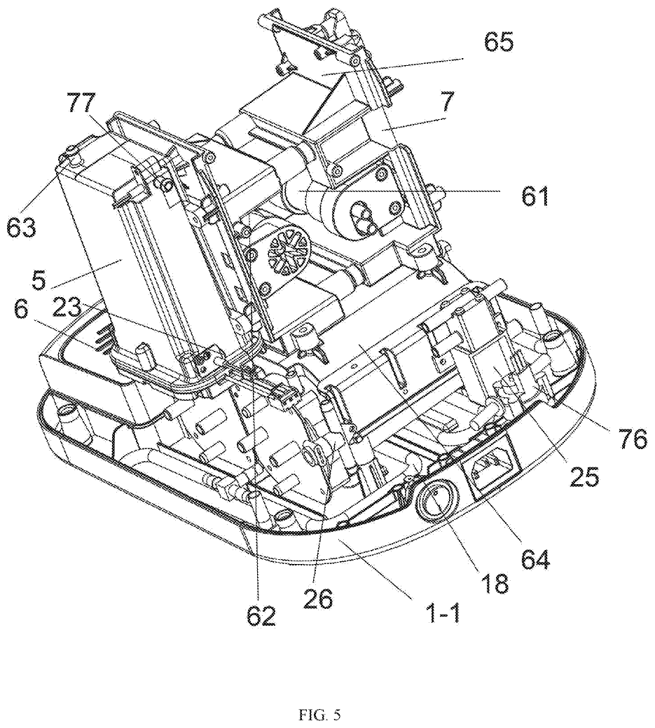

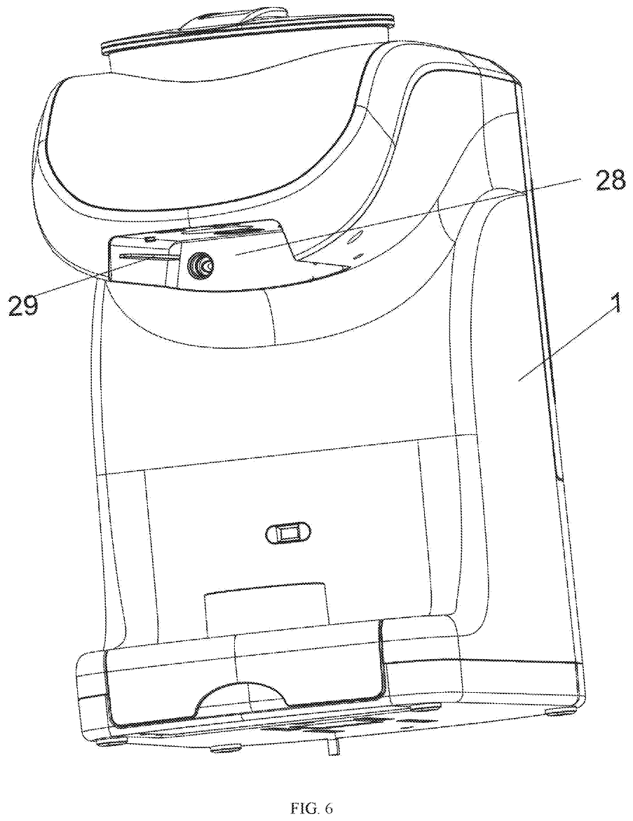

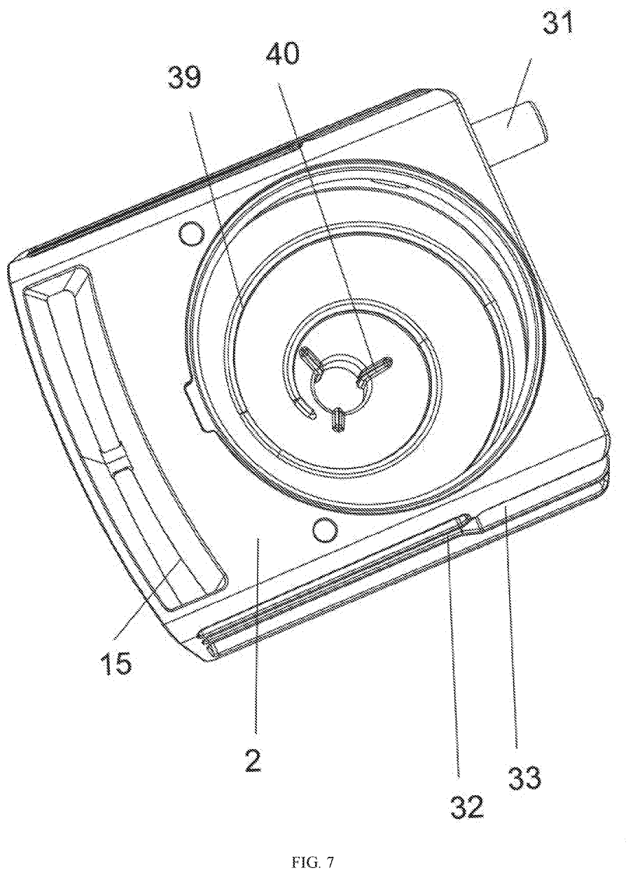

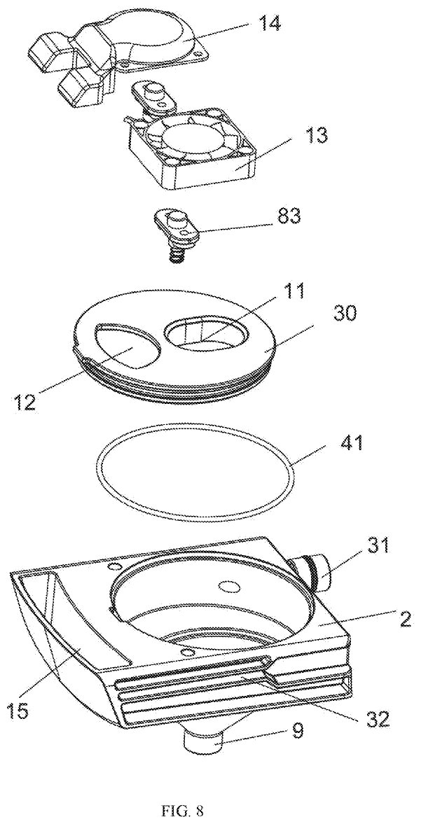

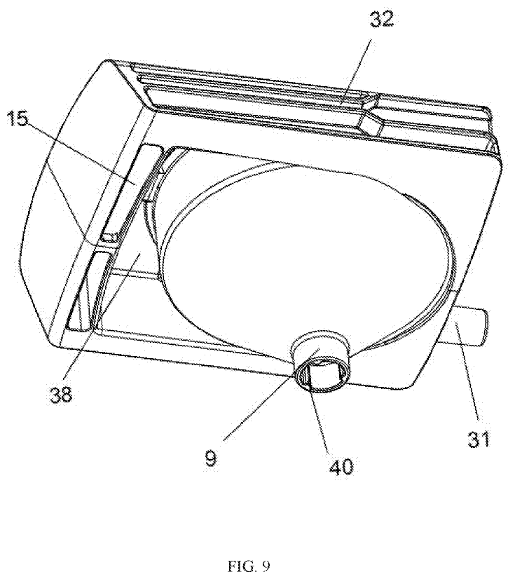

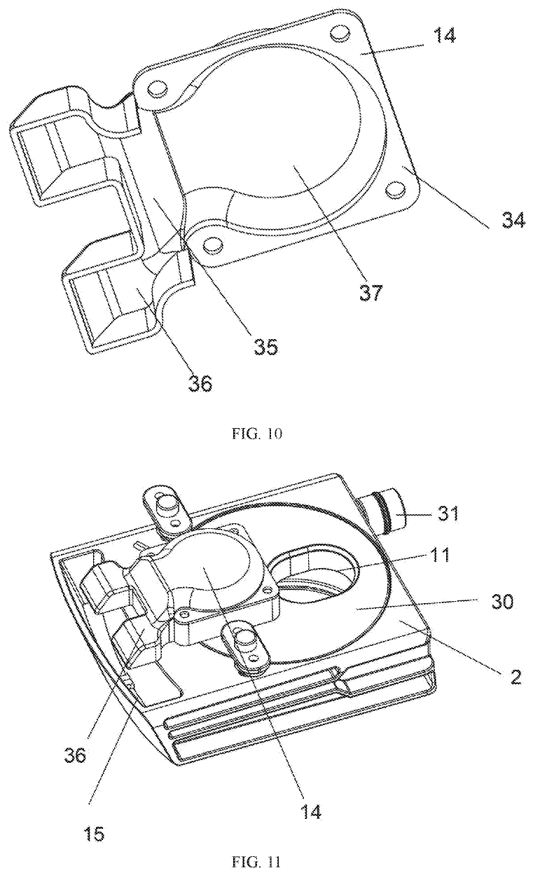

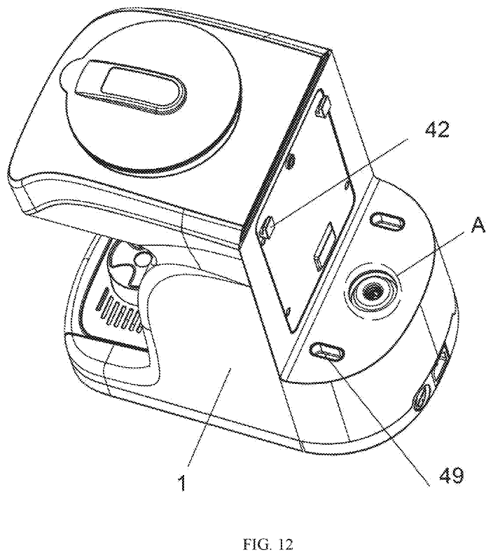

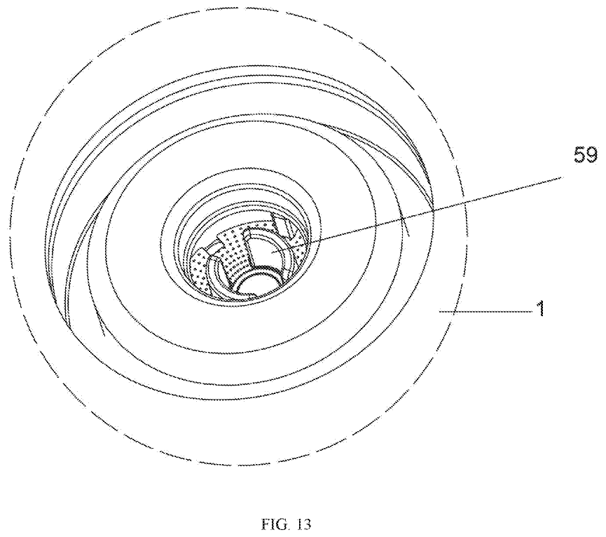

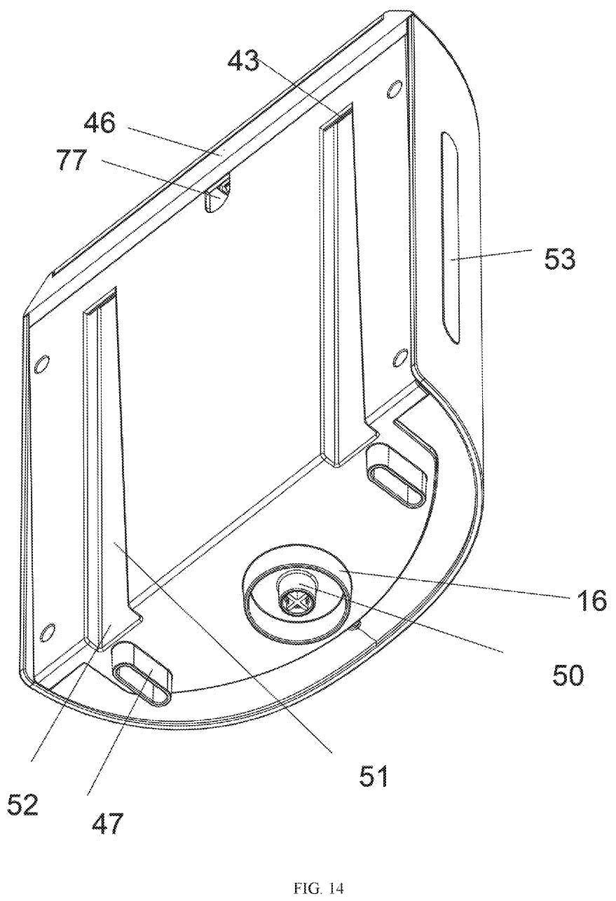

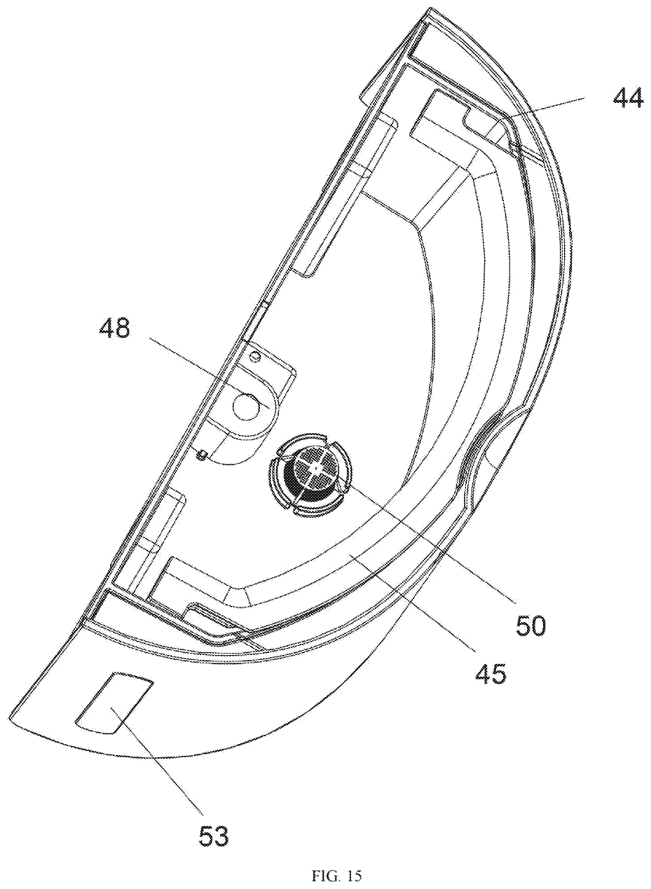

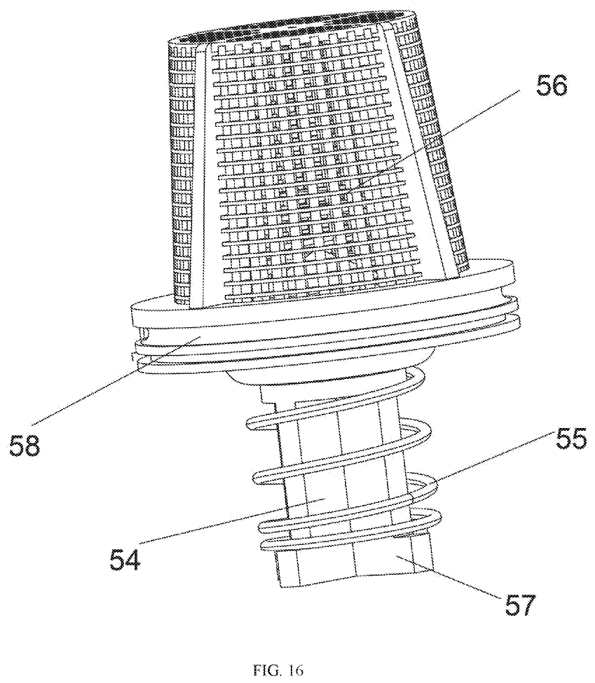

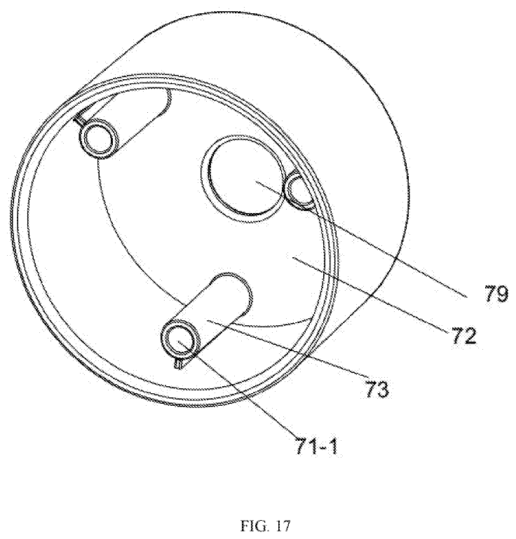

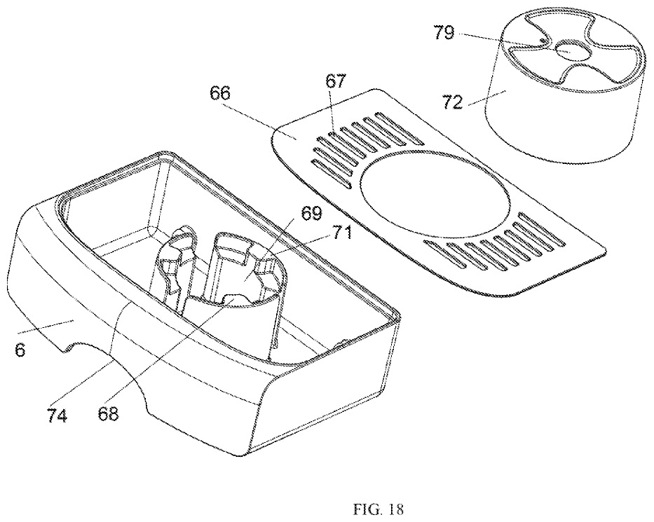

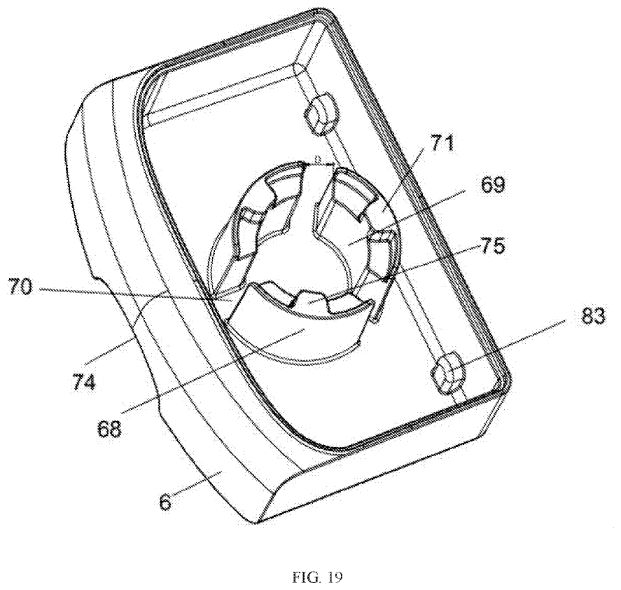

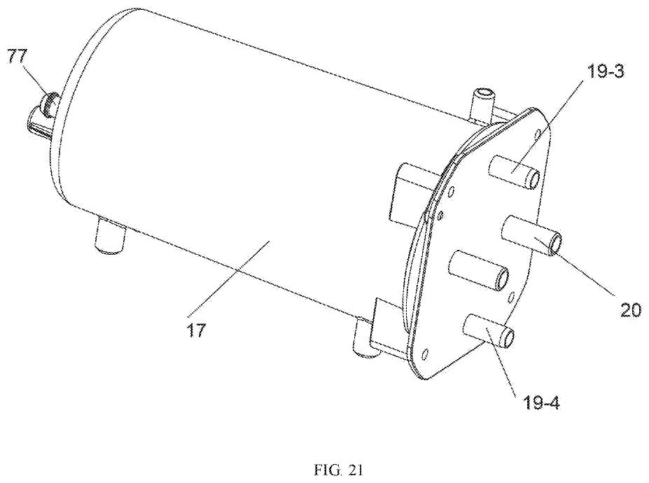

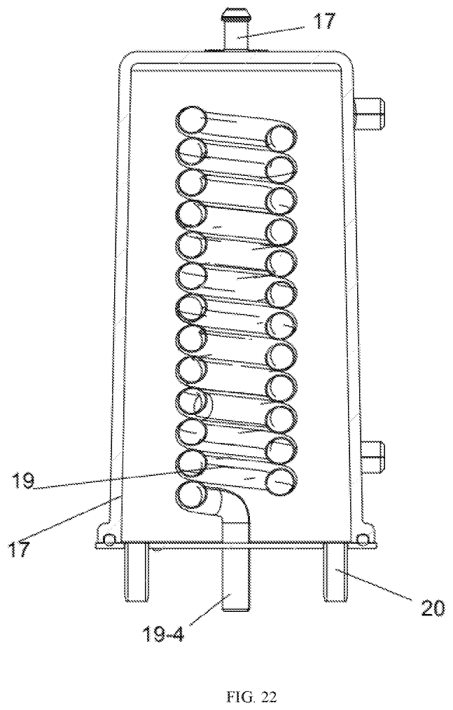

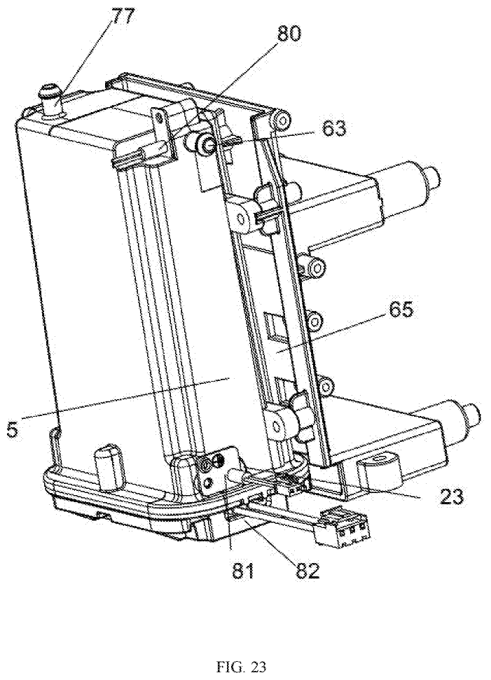

As shown in FIGS. 1-23, the milk powder brewing machine of the present disclosure comprises a shell 1, a mixing bin 2, a milk powder box 3, a water storage tank 4, a constant-temperature bin 5, a drip tray 6, a thick-film heater 7 and a controller 8, wherein the thick-film heater 7, the water storage tank 4, the milk powder box 3, the constant-temperature bin 5 and the mixing bin 2 are electrically connected to the controller 8. The mixing bin 2 is connected with the left side of the shell 1 in a drawing mode, and a milk outlet 9 is arranged below the mixing bin 2. The drip tray 6 is detachably mounted on the shell 1 and is located below the milk outlet 9 of the mixing bin 2. The water storage tank 4 is connected with the right side of the shell 1 in an inserting mode, the milk powder box 3 is arranged within the shell 1, and a powder outlet 10 of the milk powder box 3 is communicated with a powder inlet 11 of the mixing bin 2. An air extraction port 12 is provided on the mixing bin 2, and a moisture-proof assembly capable of sucking out the moisture inside the mixing bin 2 is arranged above the air extraction port 12. The moisture-proof assembly comprises a draught fan 13 with an air inlet facing the air extraction port 12 and a wind-shield cover 14 located above the draught fan 13. The side edge of the wind-shield cover 14 is provided with a first air outlet hole 15 for releasing the moisture. The constant-temperature bin 5, the thick-film heater 7 and the controller 8 are located within the shell 1, and a constant-temperature water outlet 63 formed in the constant-temperature bin 5 is communicated with the mixing bin 2. A normal-temperature water outlet 16 is formed in the water storage tank 4, and more than one horizontally-placed first cooling pipe 17 are connected to the normal-temperature water outlet 16. A horizontally-placed first spiral cooling pipe 18 is arranged below the first cooling pipes 17, and a second spiral pipe 19 is arranged in each first cooling pipe 17. The normal-temperature water flowing out from the normal-temperature water outlet 16 is divided and respectively flows into the inlet of each first cooling pipe 17. After the water flowing out from the first water outlets of all the first cooling pipes 17 join together, the water flows to the thick-film heater 7 to be heated to a temperature of 90-100° C. The outlet of the thick-film heater 7 is connected with a second water inlet 21 of the first spiral cooling pipe 18, and a second water outlet 22 of the first spiral cooling pipe 18 is connected with a constant-temperature water inlet 23 of the constant-temperature bin 5 through a second spiral pipe 19.

Further, to improve the cooling effect, there are two first cooling pipes, which respectively are a first cooling pipe A17-1 and a first cooling pipe B17-2. A second spiral pipe A19-1 is arranged in the first cooling pipe A17-1, and a second spiral pipe B19-2 is arranged in the first cooling pipe B17-2. The second water outlet 22 of the first spiral cooling pipe 18 is connected with a third water inlet 19-3 of the second spiral pipe A19-1, and a third water outlet 19-4 of the second spiral pipe A19-1 is connected with a three-way solenoid valve 25. The pipeline between the three-way solenoid valve 25 and the second spiral pipe A19-1 is provided with a temperature detector 76 capable of transmitting the data information to the controller 8 according to the temperature condition such that the three-way solenoid valve 25 is controlled by the controller to switch between different pipelines. The temperature detector 76 and the three-way solenoid valve 25 are electrically connected to the controller 8. One ends of the two outlets of the three-way solenoid valve 25 are connected to a three-way pipe 26, and the other ends of the two outlets of the three-way solenoid valve 25 are connected to the third water inlet 19-3 of the second spiral pipe B19-2. The first pipe opening of the three-way pipe 26 is connected with the three-way solenoid valve 25, the second pipe opening of the three-way pipe 26 is connected with the constant-temperature bin 5, and the third pipe opening of the three-way pipe 26 is connected with the third water outlet 19-4 of the second spiral pipe B19-2. In this embodiment, to allow a user to conveniently check whether a milk bottle is placed in place, and to enable the control system to be automatically initiated, the left side of the shell 1 is provided with an infrared sensor 78 used for detecting whether the milk bottle is placed in place. The infrared sensor 78 is electrically connected to the controller 8, and the bottoms of first cooling pipes 17 are connected to the controller 8 through a communicating pipe 24.

Further, to realize real-time monitoring of the flow, a flow meter 27 is arranged at the inlet of the thick-film heater 7.

As the structure of the milk powder box 3 capable of regularly discharging the milk powder has been disclosed in, for instance, the patent 2018220673474, it belongs to the prior art and is briefly described herein.

Further, to facilitate the disassembly of the mixing bin 2, a mounting bin 28 is arranged on the left side of the shell 1, and sliding strips 29 are arranged on the front side and the rear side inside the mounting bin 28. The mixing bin 2 is configured to be funnel-shaped, and a top cover 30 for covering the mixing bin 2 is arranged above the mixing bin 2. The mixing bin 2 is provided with a fourth water inlet 31, and the fourth water inlet 31 is connected with the second pipe opening of the three-way pipe 26. The two sides of the mixing bin 2 are provided with sliding grooves matched with the sliding strips 29, and the sliding grooves are horizontally-arranged Y-shaped sliding grooves 32. The large opening of the Y-shaped sliding groove 32 serves as an insertion opening 33 matched with the sliding strip 29, and the end portion of the small opening of the Y-shaped sliding groove 32 is a closed structure. The powder inlet 11 is arranged on the top cover 30, and the air extraction port 12 is arranged on the top cover 30 as well. When in use, the sliding strip 29 slides after being aligned with the insertion opening 33 of the Y-shaped sliding groove 32 on each side, thereby enabling the whole mixing bin 2 to move towards the inner side of the shell 1. When the sliding strip 29 slides to the small openings of the Y-shaped groove 32, the sliding strip 29 is limited by a boss located above, which finally ensures that the whole mixing bin 2 is fixed in the mounting bin 2. Thus, a drawing-type mounting structure is achieved. When the mixing bin 2 needs to be cleaned, the residual water in the constant-temperature bin 5 may be utilized to flush the interior of the mixing bin 2 after passing through the water inlet of the mixing bin 2. When the mixing bin 2 cannot be flushed clean, the entire mixing bin 2 may be drawn out from the mounting bin 28, and then the top cover 30 may be removed, thus exposing the internal structure to achieve a quick cleaning. By means of the aforesaid structural design, the mixing bin 2 may be flushed after being disassembled or directly flushed using the residual water inside the milk powder brewing machine, which further improves the flushing effect while ensuring that the dead angles in the mixing bin are flushed clean.

Further, to improve the air exhausting efficiency, and finally prevent the powder outlet of the milk powder box from being wetted, the wind-shield cover 14 further comprises a cover plate 34 for covering the whole draught fan 13. The cover plate 34 is fixed inside the shell 1, and the right side of the cover plate 34 is provided with an inclined and closed flow guide air duct 35. The other end of the flow guide air duct 35 is provided with a second channel 36 with an open lower portion and a closed upper portion, and the second channel 36 is communicated with the flow guide air duct 35. The cover plate 34 and the draught fan 13 are arranged at intervals to form a first air duct 37, and the first air duct 37 is communicated with the flow guide air duct 35. There are two or more first air outlet holes 15, which extend throughout the mixing bin 2 from top to bottom. An air outlet hole of the second channel 36 is communicated with the upper end of the corresponding first air outlet hole 15, and the lower portion of the first air outlet hole 15 is exposed in the air. It is desirable that, in this embodiment, there are two second channels, and in the implementation of the present disclosure, there may be three, four or more second channels.

Further, to facilitate the operation, an operation opening 38 is provided below the mixing bin 2 for allowing users' fingers to enter to draw out the mixing bin 2 from the shell 1.

Further, to improve the internal mixing effect, the inner wall of a bowl-shaped pipe of the mixing bin 2 is provided with a spiral-shaped first guide convex rib 39, and the inner wall of a lower pipe of the mixing bin 2 is provided with a second guide convex rib 40 extending downwards along the interior of the lower pipe. The lower pipe of the mixing bin 2 serves as the milk outlet 9. The starting point of the second guide convex rib 40 is located in the bowl-shaped pipe of the mixing bin 2, and the endpoint of the second guide convex rib 40 is flush with the mouth of the milk outlet 9. A first sealing ring 41 is arranged between the top cover 30 and the mixing bin 2.

Further, to achieve a convenient disassembly of the water storage tank, two L-shaped hanging hooks 42 are symmetrically arranged on the right-side surface of the shell 1, and limiting grooves 43 matched with the hanging hooks 42 are formed in one side surface of the water storage tank 4. The upper portion of the water storage tank 4 is provided with an opening which serves as the normal-temperature water inlet 44 of the water storage tank 4, and a handle 45 is hinged within the opening. The upper portion of the normal-temperature water inlet 44 is covered by a water tank cover 46, and the water tank cover 46 is detachably connected to the normal-temperature water inlet 44. The normal-temperature water outlet 16 is arranged below the water storage tank 4, a valve assembly 50 for closing the normal-temperature water outlet 16 is arranged in the normal-temperature water outlet 16, and a valve switch for opening the valve assembly 50 is arranged on the shell 1. Guideposts 47 are respectively arranged on two sides of the bottom of the water storage tank 4, and guide holes 49 matched with the guideposts 47 are formed in the shell 1. A liquid level sensor 48 for detecting the liquid level in the water storage tank 4 is arranged in the water storage tank 4, and the liquid level sensor 48 is electrically connected to the controller 8. In this embodiment, there are two L-shaped hanging hooks, and in the implementation of the present disclosure, there may be three, four or more hanging hooks. Moreover, the handle 45 may be exposed outside the normal-temperature water inlet 44 after being rotated for allowing a user to grasp.

Further, to make the disassembly convenient, a guide channel 51 extending downwards along the water storage tank 4 is arranged below each limiting groove 43. The lower portion of the guide channel 51 is a first opening 52 formed in the bottom surface of the water storage tank 4, and the first opening 52 is not communicated with the interior of the water storage tank 4.

Further, to prevent water from leaking from the water outlet during disassembly, transparent observation windows 53 are arranged on two sides of the water storage tank 4. The valve assembly 50 comprises a push rod 54, a compression spring 55, and a first filtering cover 56. A cross-shaped limiting block 57 is arranged below the push rod 54, and a second sealing ring 58 matched with the inner wall of the normal-temperature water outlet 16 is sleeved above the push rod 54. The compression spring 55 is sleeved in the push rod 54, and the lower end of the compression spring 55 abuts against the limiting block 57. The second sealing ring 58 is located outside the compression spring 55. The first filtering cover 56 is fixed above the normal-temperature water outlet 16, and the first filtering cover 56 covers the push rod 54 and the compression spring 55 located below. The valve switch comprises a push pin 59 matched with the bottom of the limiting block 57 for pushing the limiting block 57 up, and the second sealing ring 58 is separated from the inner wall of the normal-temperature water outlet 16 when the limiting block 57 is pushed up.

Further, to conveniently store the milk powder, the top of the milk powder box 3 is covered by a milk powder cover 60, and the milk powder cover 60 is located above the shell 1.

Further, to improve the working efficiency while achieving a fast water pumping, a first water pump 61 is arranged on the pipeline connecting the normal-temperature water outlet 16 of the water storage tank 4 and the first cooling pipe A17-1, and a second water pump 62 is arranged between the constant-temperature water outlet 63 of the constant-temperature bin 5 and the pipeline communicated with the mixing bin 2.

Further, to make the overall structure more compact, a cooling pipe fixing frame 64 is arranged above the two first cooling pipes 17, and the cooling pipe fixing frame 64 is fixed within a base 1-1 of the shell 1 through screws. The two sides of the upper portion of the cooling pipe fixing frame 64 are respectively provided with a supporting frame 65. The thick-film heater 7 is vertically arranged and is fixed to the supporting frame 65 on the left side through screws. The constant-temperature bin 5 is fixed to the supporting frame 65 on the right side through screws, the first water pump 61 is fixed on the supporting frame 65 on the left side, and the second water pump 62 is fixed on the supporting frame 65 on the right side.

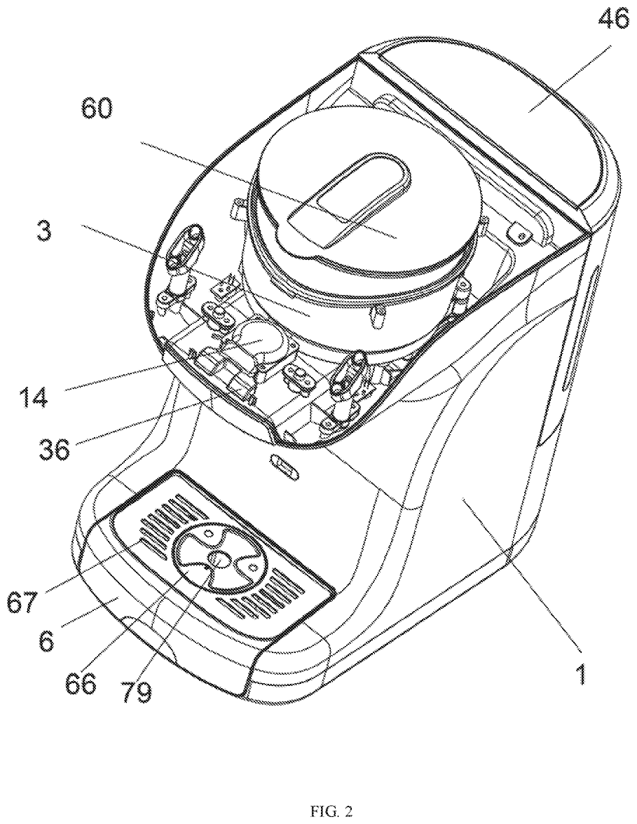

Further, to make the structure simpler and the operation more convenient, the drip tray 6 is configured to be a recessed structure with an opening in the top, and a sealing cover 66 is arranged on the drip tray 6. A plurality of first through-holes 67 for allowing water drops to pass through are formed in the sealing cover 66, and at least two arc-shaped supporting platforms 68 extending upwards from the bottom of the drip tray 6 are arranged in the drip tray 6. All of the arc-shaped supporting platforms 68 define a circular limiting platform 69 with a gap D between every two adjacent arc-shaped supporting platforms 68. All the gaps D form a first limiting area 70, and a second limiting platform 71 is arranged above each arc-shaped supporting platform 68. All the second limiting platforms 71 form a second limiting area 75, and the height of the second limiting area 75 is higher than that of the first limiting area 70. A feeding bottle mounting platform 72 is sleeved outside the circular limiting platform 69, and positioning rods 73 capable of being inserted into the gaps D are arranged below the feeding bottle mounting platform 72. After the circular limiting platform 69 is rotated, the positioning rods 73 are placed into the second limiting platform 71. An operation gap 74 is formed at the lower portion of the left side of the drip tray 6, and an operation hole 79 is formed in the feeding bottle mounting platform 72 for allowing users' fingers to enter to operate. During use, when the height of the feeding bottle is enough, the distance between the bottle mouth and the milk outlet is small, which prevents the milk from splattering such that the rotation of the feeding bottle mounting platform 72 is unnecessary. As shown in FIG. 2, at this point, each positioning rod 73 is placed into a limiting hole corresponding to the first limiting area 70 (formed by the gap D between two adjacent arc-shaped supporting platforms 8). When the feeding bottle is small and the height is not enough, for the distance between the bottle mouth and the milk outlet is large, it is necessary to adjust the height of the feeding bottle mounting platform 72. Under such circumstances, the whole feeding bottle mounting platform may be lifted 72, thus ensuring the positioning rods 73 are far away from the first limiting area 70. Subsequently, the feeding bottle mounting platform 72 is rotated such that the positioning rods 73 are located right above the second limiting area 75, and then the feeding bottle mounting platform is put down such that the positioning rods 73 are placed on the second limiting platform 71. In this way, the height of the whole feeding bottle mounting platform 72 is raised. After the small feeding bottle is put down, its bottle mouth is close to the milk outlet, allowing the milk flowing from the milk outlet to precisely enter the mouth of the small feeding bottle. Thus, the spattering of milk is avoided. Through adopting the aforesaid design, the height of the feeding bottle mounting platform 72 may be adjusted according to actual needs. As the splattering problem is solved, a smooth receiving of milk is achieved, which makes the milk powder brewing machine of the present disclosure universal for bottles with different heights.

To facilitate the positioning, two first magnets 83 are symmetrically arranged on the right side of the drip tray 6, and a positioning magnet 71-1 engaged with the upper end of the second limiting platform 71 in an attraction manner is arranged in the positioning rod 73. Additionally, a second magnet matched with the first magnet 83 is arranged at the corresponding position of the shell 1. When the whole drip tray is mounted in the shell 1 at the later stage, the first magnet 83 attracts the second magnet on the shell 1, thereby realizing the fixation. Meanwhile, as the positioning magnet arranged in the positioning rod 73 attracts the upper end of the second limiting platform 71, the feeding bottle mounting platform is positioned at a higher height. Therefore, the upper end of the second limiting platform 71 may be made of magnetic material or a material capable of being attracted by the positioning magnet 71-1.

To reach the balance of internal water flowing, balance holes 77 are respectively formed in the first cooling pipes 17, the water storage tank 4, and the constant-temperature bin 5.

To improve the constant-temperature effect, a second NTC temperature sensor 80 is arranged at the constant-temperature water outlet 63 of the constant-temperature bin 5, and a first NTC temperature sensor 81 is arranged at the constant-temperature water inlet 23 of the constant-temperature bin 5. A PTC heater 82 for heating the water in the constant-temperature bin 5 is arranged at the bottom of the constant-temperature bin 5. The second NTC temperature sensor 80, the first NTC temperature sensor 81, and the PTC heater 82 are electrically connected with the controller 8. According to the aforesaid structural design, through obtaining the water temperature at two different positions, the real-time detection of the water temperature in the constant-temperature bin 5 becomes precise. The first NTC temperature sensor 81 detects the water temperature entering the constant-temperature water inlet 23 of the constant-temperature bin 51, and the second NTC temperature sensor 80 detects the water temperature after the water entering the constant-temperature bin 5 and the water remaining in the constant-temperature bin 5 are mixed. Meanwhile, once the detected temperature in the constant-temperature bin 5 is excessively low, the PTC heater 82 arranged at the bottom of the constant-temperature bin 5 is immediately initiated to heat the water, thereby always keeping the constant temperature of the water in the constant-temperature bin 5. In this way, the constant-temperature effect is significantly improved. The process of collecting the temperature information of the first NTC temperature sensor 81 and the temperature of the second NTC temperature sensor 80 in this embodiment belongs to the prior art, which is briefly described herein.

During operation, the hot water (90-100° C.) flowing out from the outlet of the thick-film heater 7 passes through the first spiral cooling pipe 18 and is pre-cooled by the first spiral cooling pipe (the main function of the first spiral cooling pipe 18 is to cool the water by air). Thus, the pre-cooling is realized. Subsequently, the hot water enters the second spiral pipe A19-1 (the second spiral pipe A19-1 is arranged in the first cooling pipe A17-1) and is cooled by the water in the first cooling pipe A17-1. Through the heat exchange, primary water cooling is achieved. The hot water flowing out from the second spiral pipe A19-1 passes through the NTC temperature sensor, and the water temperature is detected by the NTC sensor.

If the water temperature after the primary water cooling is lower than the preset value (the preset temperature is normally about 40-45° C., suitable for brewing the milk powder), the three-way solenoid valve 25 is controlled by the controller, and in response to that, the inlet A and the outlet B of the three-way solenoid valve 25 are opened, and the outlet C is closed. At this point, the water being primarily cooled directly flows into the constant-temperature cabin 5 (the water in the constant-temperature cabin 5 is directly used for brewing the milk powder). Certainly, in this process, a small portion of the water flowing out from the outlet B may flow into the second spiral pipe B19-2 through a three-way joint (hose joint) and then flow to the outlet C of the three-way solenoid valve 25 through the second spiral tube B19-2. However, as the outlet C is in a closed state, the waterway isn't formed (namely, the second spiral pipe B19-2 is filled with a portion of water at most, which does not affect much).

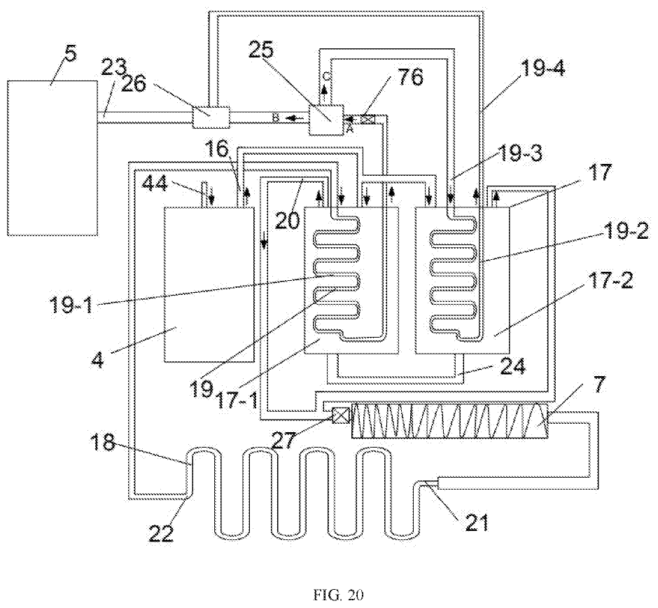

If the water temperature is higher than the preset value after the primary water cooling, the inlet A of the three-way solenoid valve 25 is communicated with the outlet C, and the outlet B is closed. At this point, the water being primarily cooled flows into the second spiral pipe B19-2 (shown in FIG. 20) through the outlet C and is then further cooled by the water in the first cooling pipe B17-2, namely, undergoing the secondary water cooling. The water flowing out from the second spiral pipe B19-2 eventually flows into the constant-temperature bin 5 (similarly, there may be a small portion of the water flowing to the outlet B of the three-way solenoid valve 25 through the three-way joint, but which does not form a waterway because the outlet B is in a closed state). Finally, through the primary water cooling or the secondary water cooling, the variation of water temperature is achieved.

In this embodiment, the water-cooling frequency may be adjusted based on the variation of temperature. In summer, the secondary water cooling is normally required as the ambient temperature is high, but in winter, only the primary water cooling is required as the ambient temperature is low. The aforesaid design makes the waterway structure of the present disclosure more energy saving. The primary water cooling or secondary water cooling may be chosen based on the precise judgment of the NTC sensor (the temperature detector 76). Moreover, according to the aforesaid structural design, the thick-film heater 7 is utilized to rapidly heat the water delivered into the thick-film heater 7 to a temperature of 90-100° C., and through the spiral-shaped configuration of the first spiral cooling pipe 18, the duration of water flowing is significantly prolonged, thus achieving an ideal cooling effect. In this way, the pre-cooling of the water is realized. The pre-cooled water passes through the first spiral cooling pipe 18 for water cooling. At this point, the water in the first spiral cooling pipe 18 exchanges heat with the first cooling pipe 17, which effectively cools the water in the first spiral cooling pipe 18. Subsequently, the water flowing into the first cooling pipe 17 from the water storage tank 4 is heated, and then the heated water in the first cooling pipe 17 is delivered into the thick-film heater 7, thereby enabling the thick-film heater 7 to raise the water temperature to 90-100° C. within a short time. Thus, the reuse of energy is realized. The water in the water storage tank 4 passes through the first cooling pipe 17 and then enters the thick-film heater 7, allowing the heat generated during the heat exchange of the first spiral cooling pipe 18 to be effectively utilized to preheat the water entering the thick-film heater 7. The aforesaid design not only ensures the temperature of the water heated by the thick-film heater 7, but also improves the energy-saving effect. As the aforesaid structural design enhances the cooling effect, realizes instant heating, and achieves reuse of energy, the energy-saving effect of the present disclosure is significantly improved.

In this embodiment, to master the temperature condition of the temperature detector 76, a controller 8 is pre-arranged, and temperature requirements are preset in the controller 8. The preset temperature may be lower in summer and higher in winter. During summer, the temperature of the corresponding pipeline detected by the temperature detector 76 is compared with the preset temperature in the controller 8. When the detected temperature is higher than the preset temperature, the pipeline of the three-way solenoid valve 25 is immediately switched by the controller 8, thus allowing water to flow into the second spiral pipe B19-2 for the secondary water cooling, and when the detected temperature is lower than the preset temperature, the pipeline of the three-way solenoid valve 25 is switched by the controller 8, thereby ensuring that the water directly flows into the three-way pipe 26 and then enters the constant-temperature bin 5 instead of flowing into the second spiral pipe B19-2. It should be noted that, how to preset the temperature in the controller 8, how the controller collects the temperature information of the temperature detector 76 and compares the obtained temperature with the preset temperature, and how the controller controls the three-way solenoid valve 25 to switch the pipeline are all conventional means in the art. As belonging to the prior art, they are briefly described herein.

Moreover, to facilitate the later disassembly and water feeding, and to thoroughly clean the inner bottom of the water storage tank 4, the water storage tank 4 is configured to be a detachable structure. The disassembly and assembly processes of the water storage tank 4 are: when disassembling, the whole water storage tank 4 may be directly lifted up from the shell 1 through holding the water storage tank 4 by hands. Then, the water tank cover 46 is opened and water is directly quickly fed into the water storage tank 4. When the water storage tank 4 is filled with water, the handle 45 hidden in the normal-temperature water inlet 44 is rotated to be partially exposed outside the water inlet, thereby allowing a user to conveniently grasp. At this point, through grasping the handle, the water storage tank 4 may be lifted by one hand. When assembling, the first openings 52 on the side edge are aligned with the hanging hooks 42, the guideposts 47 are aligned with the guide holes 49, and then the water storage tank 4 is moved downwards until the guideposts 47 are engaged with the guide holes 49 and the hanging hooks 42 are limited in the limiting grooves 43. After that, the handle 45 is rotated such that it is hidden in the normal-temperature water inlet 44 again, and the water inlet is covered by the sealing cover. Thus, the assembly of the water storage tank 4 is completed. Through adopting the aforesaid structural design, the water tank may be disassembled once being lifted and assembled once being inserted. Furthermore, the full opening design of the water storage tank 4 makes the water feeding efficiency higher and the cleaning of the interior of the water storage tank 4 more convenient. By means of the aforesaid structure, convenient disassembly and assembly of the water storage tank are achieved. Additionally, through the arrangement of the valve assembly 50 and the valve switch, when the water storage tank is separated from the shell 1, the water is effectively prevented from flowing out from the lower portion of the water storage tank, and when the shell 1 and the water storage tank 4 are assembled, the water may flow out.

In addition, through the moisture-proof assembly arranged in the present disclosure, when hot water flowing out from the constant-temperature bin 5 enters the mixing bin 2, to prevent the hot air from surging into the powder outlet 10 of the milk powder box 3, the draught fan 13 is immediately initiated. The draught fan 13 propels the hot air from the air extraction port 12 to flow into the first air duct 37 first, then flow into the second channel 36 through the inclined flow guide air duct 35, and finally be discharged from the first air outlet 15. In this way, the powder outlet of the milk powder box 3 located above the mixing bin and the interior of the milk powder box are effectively protected from being wetted by the hot air.

The milk powder brewing machine of the present disclosure has the following advantages: first, according to the present disclosure, the water storage tank may be conveniently disassembled and the interior of the constant-temperature bin may be thoroughly cleaned; second, through the arrangement of the moisture-proof assembly, the powder outlet of the milk powder box and the interior of the milk powder box are prevented from being wetted; third, the height of the feeding bottle mounting platform may be adjusted according to actual needs, which realizes a smooth milk receiving, avoids the milk from splattering, and finally makes the feeding bottle mounting platform universal for various feeding bottles; fourth, the constant-temperature effect is significantly improved; fifth, the heat generated during the heat exchange of the first spiral cooling pipe is effectively utilized to preheat the water entering the water heater, which not only ensures the temperature of the water heated by the water heater but also improves the energy-saving effect. As the aforesaid structural design enhances the cooling effect, realizes an instant heating, and achieves a reuse of energy, the energy-saving effect of the present disclosure is significantly improved.

The above are merely preferred embodiments of the present disclosure, and the scope of the present disclosure is not limited to the embodiments described above. All technical solutions formed by equivalent modification or replacement shall fall into the scope of the present disclosure.

What is claimed is:

1. A milk powder brewing machine of the present disclosure, comprising:
a shell,
a mixing bin,
a milk powder box,
a water storage tank,
a constant-temperature bin,
a drip tray,
a thick-film heater, and
a controller, wherein the thick-film heater, the water storage tank, the milk powder box, the constant-temperature bin and the mixing bin are electrically connected to the controller, wherein the mixing bin is connected with a left side of the shell in a drawing mode, and a milk outlet is arranged below the mixing bin, wherein the drip tray is detachably mounted on the shell and is located below the milk outlet of the mixing bin, wherein the water storage tank is connected with a right side of the shell in an inserting mode, the milk powder box is arranged within the shell, and a powder outlet of the milk powder box is communicated with a powder inlet of the mixing bin, wherein an air extraction port is provided on the mixing bin, and a moisture-proof assembly capable of sucking out the moisture inside the mixing bin is arranged above the air extraction port, wherein the moisture-proof assembly comprises a draught fan with an air inlet facing the air extraction port and a wind-shield cover located above the draught fan, wherein the side edge of the wind-shield cover is provided with a first air outlet hole for releasing the moisture, wherein the constant-temperature bin, the thick-film heater and the controller are located within the shell, and a constant-temperature water outlet formed in the constant-temperature bin is communicated with the mixing bin, wherein a normal-temperature water outlet is formed in the water storage tank, and a plurality of cooling pipes are horizontally-placed and are connected to the normal-temperature water outlet, wherein a horizontally-placed spiral cooling pipe is arranged below the plurality of cooling pipes, and a respective spiral pipe is arranged in each cooling pipe of the plurality of cooling pipes, wherein the normal-temperature water flowing out from the normal-temperature water outlet is divided and respectively flows into respective water inlet of each cooling pipe of the plurality of cooling pipes, wherein after the water flowing out from water outlets of the plurality of cooling pipes join together, the water flows to the thick-film heater, wherein the outlet of the thick-film heater is connected with a water inlet of the spiral cooling pipe, and a water outlet of the spiral cooling pipe is connected with a constant-temperature water inlet of the constant-temperature bin through spiral pipe.

2. The milk powder brewing machine of claim 1, wherein the plurality of cooling pipes includes a first cooling pipe and a second cooling pipe, wherein a first spiral pipe is arranged in the first cooling pipe , and a second spiral pipe is arranged in the second cooling pipe, wherein the water outlet of the spiral cooling pipe is connected with a water inlet of the first spiral pipe, and a water outlet of the first spiral pipe is connected with a three-way solenoid valve, wherein the pipeline between the three-way solenoid valve and the second spiral pipe is provided with a temperature detector capable of transmitting the data information to the controller according to the temperature condition such that the three-way solenoid valve is controlled by the controller to switch between different pipelines, wherein the temperature detector and the three-way solenoid valve are electrically connected to the controller, wherein one ends of the two outlets of the three-way solenoid valve are connected to a three-way pipe, and the other ends of the two outlets of the three-way solenoid valve are connected to the water inlet of the second spiral pipe, wherein a first pipe opening of the three-way pipe is connected with the three-way solenoid valve, a second pipe opening of the three-way pipe is connected with the constant-temperature bin, and a third pipe opening of the three-way pipe is connected with the water outlet of the second spiral pipe, wherein the bottoms of the plurality of cooling pipes are connected to the controller through a communicating pipe.

3. The milk powder brewing machine of claim 1, wherein a flow meter is arranged at the inlet of the thick-film heater.

4. The milk powder brewing machine of claim 2, wherein a mounting bin is arranged on the left side of the shell, and sliding strips are arranged on the front side and the rear side inside the mounting bin, wherein the mixing bin is configured to be funnel-shaped, and a top cover for covering the mixing bin is arranged above the mixing bin, wherein the mixing bin is provided with a fourth water inlet, and the fourth water inlet is connected with the second pipe opening of the three-way pipe, wherein the two sides of the mixing bin are provided with sliding grooves matched with the sliding strips, and the sliding grooves are horizontally-arranged Y-shaped sliding grooves, wherein the large opening of the Y-shaped sliding groove serves as an insertion opening matched with the sliding strip, and the end portion of the small opening of the Y-shaped sliding groove is a closed structure, wherein the powder inlet is arranged on the top cover, and the air extraction port is arranged on the top cover.

5. The milk powder brewing machine of claim 4, wherein the wind-shield cover further comprises:
a cover plate for covering the whole draught fan, wherein the cover plate is fixed inside the shell, and the right side of the cover plate is provided with an inclined and closed flow guide air duct, wherein the other end of the flow guide air duct is provided with a second channel with an open lower portion and a closed upper portion, and the second channel is communicated with the flow guide air duct, wherein the cover plate and the draught fan are arranged at intervals to form a first air duct, and the first air duct is communicated with the flow guide air duct, wherein there are two or more first air outlet holes, which extend throughout the mixing bin from top to bottom, wherein an air outlet hole of the second channel is communicated with the upper end of the corresponding first air outlet hole, and the lower portion of the first air outlet hole is exposed in the air.

6. The milk powder brewing machine of claim 5, wherein an operation opening is provided below the mixing bin for allowing users' fingers to enter to draw out the mixing bin from the shell.

7. The milk powder brewing machine of claim 2, wherein the inner wall of a bowl-shaped pipe of the mixing bin is provided with a spiral-shaped first guide convex rib, and the inner wall of a lower pipe of the mixing bin is provided with a second guide convex rib extending downwards along the interior of the lower pipe, wherein the lower pipe of the mixing bin serves as the milk outlet, wherein the starting point of the second guide convex rib is located in the bowl-shaped pipe of the mixing bin, and the endpoint of the second guide convex rib is flush with the mouth of the milk outlet, wherein a first sealing ring is arranged between the top cover and the mixing bin.

8. The milk powder brewing machine of claim 1, wherein two L-shaped hanging hooks are symmetrically arranged on the right-side surface of the shell, and limiting grooves matched with the hanging hooks are formed in one side surface of the water storage tank, wherein the upper portion of the water storage tank is provided with an opening which serves as the normal-temperature water inlet of the water storage tank, and a handle is hinged within the opening, wherein the upper portion of the normal-temperature water inlet is covered by a water tank cover, and the water tank cover is detachably connected to the normal-temperature water inlet, wherein the normal-temperature water outlet is arranged below the water storage tank, a valve assembly for closing the normal-temperature water outlet is arranged in the normal-temperature water outlet, and a valve switch for opening the valve assembly is arranged on the shell, wherein guideposts are respectively arranged on two sides of the bottom of the water storage tank, and guide holes matched with the guideposts are formed in the shell, wherein a liquid level sensor for detecting the liquid level in the water storage tank is arranged in the water storage tank, and the liquid level sensor is electrically connected to the controller.

9. The milk powder brewing machine of claim 8, wherein a guide channel extending downwards along the water storage tank is arranged below each limiting groove, wherein the lower portion of the guide channel is a first opening formed in the bottom surface of the water storage tank, and the first opening is not communicated with the interior of the water storage tank.

10. The milk powder brewing machine of claim 9, wherein transparent observation windows are arranged on two sides of the water storage tank, wherein the valve assembly comprises:
a push rod, a compression spring, and a first filtering cover, wherein a cross-shaped limiting block is arranged below the push rod, and a second sealing ring matched with the inner wall of the normal-temperature water outlet is sleeved above the push rod, wherein the compression spring is sleeved in the push rod, and the lower end of the compression spring abuts against the limiting block, wherein the second sealing ring is located outside the compression spring, wherein the first filtering cover is fixed above the normal-temperature water outlet, and the first filtering cover covers the push rod and the compression spring located below, wherein the valve switch comprises:
a push pin matched with the bottom of the limiting block for pushing the limiting block up, and the second sealing ring is separated from the inner wall of the normal-temperature water outlet when the limiting block is pushed up.

11. The milk powder brewing machine of claim 1, wherein the top of the milk powder box is covered by a milk powder cover, and the milk powder cover is located above the shell.

12. The milk powder brewing machine of claim 2, wherein a first water pump is arranged on the pipeline connecting the normal-temperature water outlet of the water storage tank and the plurality of cooling pipes, and a second water pump is arranged between the constant-temperature water outlet of the constant-temperature bin and the pipeline communicated with the mixing bin.

13. The milk powder brewing machine of claim 12, wherein a cooling pipe fixing frame is arranged above the two cooling pipe, and the cooling pipe fixing frame is fixed within a base of the shell through screws, wherein the two sides of the upper portion of the cooling pipe fixing frame are respectively provided with a supporting frame, wherein the thick-film heater is vertically arranged and is fixed to the supporting frame on the left side through screws, wherein the constant-temperature bin is fixed to the supporting frame on the right side through screws, the first water pump is fixed on the supporting frame on the left side, and the second water pump is fixed on the supporting frame on the right side.

14. The milk powder brewing machine of claim 13, wherein the drip tray is configured to be a recessed structure with an opening in the top, and a sealing cover is arranged on the drip tray, wherein a plurality of first through-holes for allowing water drops to pass through are formed in the sealing cover, and at least two arc-shaped supporting platforms extending upwards from the bottom of the drip tray are arranged in the drip tray, wherein all of the arc-shaped supporting platforms define a circular limiting platform with a gap between every two adjacent arc-shaped supporting platforms, wherein all gaps form a first limiting area, and a second limiting platform is arranged above each arc-shaped supporting platform, wherein all the second limiting platforms form a second limiting area, and the height of the second limiting area is higher than that of the first limiting area, wherein a feeding bottle mounting platform is sleeved outside the circular limiting platform, and positioning rods capable of being inserted into the gaps are arranged below the feeding bottle mounting platform, wherein after the circular limiting platform is rotated, the positioning rods are placed into the second limiting platform, wherein an operation gap is formed at the lower portion of the left side of the drip tray, and an operation hole is formed in the feeding bottle mounting platform for allowing users' fingers to enter to operate.

15. The milk powder brewing machine of claim 15, wherein two first magnets are symmetrically arranged on the right side of the drip tray, and a positioning magnet engaged with the upper end of the second limiting platform in an attraction manner is arranged in the positioning rod.

16. The milk powder brewing machine of claim 16, wherein a second negative temperature coefficient (NTC) temperature sensor is arranged at the constant-temperature water outlet of the constant-temperature bin, and a first NTC temperature sensor is arranged at the constant-temperature water inlet of the constant-temperature bin, wherein a positive temperature coefficient (PTC) heater for heating the water in the constant-temperature bin is arranged at the bottom of the constant-temperature bin, wherein the second NTC temperature sensor, the first NTC temperature sensor and the PTC heater are electrically connected with the controller.
